(19) United States
(12) Patent Application Publication
(10) Pub. No.: US 2012/0297621 A1
(43) Pub. Date: Nov. 29, 2012

(54) METHOD OF MANUFACTURING WATER HEATER JACKET

(76) Inventors: Ming C. Kuo, Fox Point, WI (US); David Wallace, Florence, SC (US); Bogdan Bunescu, Kitchener (CA); Frank Hodges, Florence, SC (US)

(21) Appl. No.: 13/466,578

(22) Filed: May 8, 2012

Related U.S. Application Data
(60) Provisional application No. 61/489,121, filed on May 23, 2011.

(51) Int. Cl. B23P 15/00; B32B 38/14; B23P 17/00; B32B 37/02

(52) U.S. Cl. 29/890.14; 156/218; 29/527.2

(57) ABSTRACT

A method for manufacturing a jacket for a storage-type water heater includes applying a coating to a sheet of metal, printing content on the coating to form a printed sheet, and forming the printed sheet into a finished jacket. The coating may be a thin film or may be a layer of paint. The content may be printed with an inkjet printer.

### CROSS-REFERENCE TO RELATED APPLICATIONS

This application claims the benefit under 35 U.S.C. 119(e) of the filing date of U.S. Provisional Application No. 61/489,121, filed May 23, 2011, the entire contents of which are incorporated herein by reference.

### BACKGROUND

The present invention relates to a method for manufacturing a water heater jacket.

### SUMMARY

The invention provides a method of manufacturing a water heater, the method comprising: (a) providing a water storage tank for storing water; (b) providing a heating source for heating water stored in the tank; (c) providing a sheet of metal including a first surface; (d) applying a coating to the first surface; (e) printing content onto the coating; (f) forming the sheet into a cylinder, the cylinder including two open ends; and (g) positioning the water storage tank and the heating source within the cylinder.

In some embodiments, step (d) includes applying a UV-curable paint, the method further comprising the step of curing the coating by exposing the coating to UV light between steps (d) and (e). In some embodiments, step (e) includes printing content with an inkjet printer. In some embodiments, step (e) occurs before step (f). In some embodiments, step (d) is executed in no more than thirty seconds; wherein the step of curing the coating is executed in no more than thirty seconds; and wherein step (e) is executed in no more than thirty seconds. In some embodiments, step (d) includes applying a film having a thermoplastic layer and an adhesive such that the adhesive secures the film to the first surface. In some embodiments, step (e) occurs before step (d). In some embodiments, step (e) occurs after step (d).

The invention also provides a method of manufacturing a water heater jacket, the method comprising: (a) providing a sheet of metal including a first surface; (b) applying a paint to the first surface, resulting in a painted sheet; (c) curing the paint, resulting in a cured sheet; (d) printing content onto the cured sheet, resulting in a printed sheet; and (e) forming the printed sheet into a cylinder, the cylinder including two open ends and being sized to fit over a water heater storage tank.

In some embodiments, step (b) includes applying a UV-curable paint; and wherein step (c) includes exposing the paint to UV light. In some embodiments, step (d) includes printing content with an inkjet printer. In some embodiments, each of steps (b), (c), and (d) is accomplished in no more than thirty seconds. In some embodiments, the invention further comprises: applying a clear paint to the printed sheet, resulting in a clear painted sheet; and curing the clear paint, resulting in a cured clear painted sheet. In some embodiments, the invention further comprises: cleaning the first surface prior step (b). In some embodiments, step (d) occurs before step (e).

The invention also provides a method of manufacturing a water heater jacket, the method comprising: (a) providing a sheet of metal including a first surface; (b) providing a film including a thermoplastic layer and an adhesive; (c) securing the film to the first surface with the adhesive; (d) printing content onto the thermoplastic layer, resulting in a printed sheet; and (e) forming the printed sheet into a cylinder, the cylinder including two open ends.

In some embodiments, step (d) occurs before step (c). In some embodiments, step (d) occurs after step (c). In some embodiments, step (d) occurs before step (e). In some embodiments, step (d) includes printing with an inkjet printer.

The invention also provides a method of manufacturing a water heater jacket comprising the steps of: (a) providing a sheet of steel; (b) applying a primer coat to the sheet of steel; (c) applying a color coat over the primer coat; (d) printing label information on top of the color coat; (e) applying a clear top coat over the color coat and label information to create a printed sheet of steel; and (f) forming the printed sheet of steel into a cylinder of a desired diameter to surround a water heater tank.

In some embodiments, step (a) includes providing the sheet of steel as part of a coil of steel, the method further comprising the step of cutting the sheet of steel from the coil of steel after step (c). In some embodiments, step (b) includes applying a UV curable primer coat to the sheet of steel and curing the primer coat under UV light. In some embodiments, step (c) includes applying a UV curable liquid color coat over the primer and curing the color coat under UV light. In some embodiments, step (d) includes printing the label information with UV curable ink using an inkjet printer.

### BRIEF DESCRIPTION OF THE DRAWINGS

FIG. 1 illustrates a water heater including a jacket manufactured according to the method of the present invention.

FIG. 2 illustrates the components used in fabricating the jacket.

FIG. 3 illustrates a printed sheet to be formed into the jacket.

FIG. 4 illustrates a finished jacket.

FIG. 5 is a flow chart of a first process for manufacturing the jacket according to the method of the present invention.

FIG. 6 is a flow chart of a second process for manufacturing the jacket according to the method of the present invention.

FIG. 7 is a flow chart of a third process for manufacturing the jacket according to the method of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

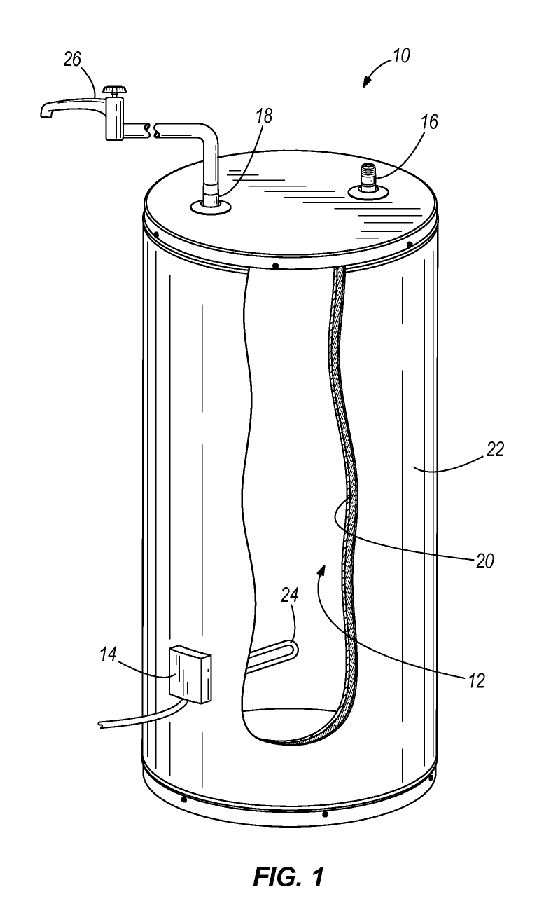

FIG. 1 illustrates an storage-type water heater 10 having a storage tank 12, a heating source 14, a cold water inlet 16, a hot water outlet 18, and a layer of insulation 20. The water heater 10 includes a jacket 22 made according to the method of the present invention. The jacket 22 surrounds the storage tank 12 and layer of insulation 20.

The storage tank 12 is typically constructed of sheet steel and may be glass-lined to reduce the likelihood of corrosion. Other corrosion resisting measures, such as a sacrificial anode, can be employed to reduce the likelihood of corrosion of the storage tank walls. The storage tank 12 contains water.

The heating source 14 may include one or more an electrical heating elements 24, as illustrated, or may be a gas burner in a combustion chamber, usually below the storage tank 12, with a flue extending through the storage tank 12. The invention is applicable to a method for manufacturing a jacket 22 for a water heater, without regard to whether the water heater is an electric water heater or a gas-fired water heater. The heating source 14 generates heat which is transferred to the water stored in the storage tank 12 to heat the water.

The cold water inlet 16 places a supply of water in communication with the storage tank 12. The cold water inlet 16 often includes a dip tube that delivers the cold water to a bottom portion of the storage tank 12. The supply of water typically applies a pressure (e.g., head pressure) to the cold water being delivered to the storage tank 12 via the cold water inlet 16.

The hot water outlet 18 communicates between the storage tank 12 and a hot water faucet 26 or other valve. The hot water faucet 26 often communicates with water near the top of the storage tank 12, where the hottest water tends to collect. When the hot water faucet 26 is opened, the pressure of cold water displaces hot water out of the storage tank 12 to the faucet 26. The newly-introduced cold water lowers the overall temperature of water in the storage tank 12, which triggers the heating source 14 to heat the water in the storage tank 12.

The layer of insulation 20 can take several forms, including foamed-in-place insulation, fiberglass batt insulation, and a combination of the two. The layer of insulation 20 surrounds the storage tank 12 to reduce heat transfer from water in the tank 12 to the ambient air around the water heater 10.

Known water heater jackets are produced according to the following process: (1) size metal (for example, steel) into sheets for forming jackets; (2) punch holes and other areas for parts in the sheets; (3) fabricate the sheets into the form of jackets (for example by rolling and locking); (4) clean and prepare metal substrates of jackets with multiple (for example, three to seven) stages of a washing system; (5) oven dry the surfaces of jackets for about 20 minutes at temperatures of 250-300 degrees Fahrenheit; (6) allow jackets to cool down for 5 to 15 minutes; (7) paint jackets by spraying liquid paint or spraying powder paint; and (8) cure painted jackets in oven for 30 to 40 minutes at 400 degrees Fahrenheit.

Using known techniques, safety labels and information labels are applied after the jackets are painted. Labels are often manually applied, which may result in an overall unattractive appearance for the water heater due to the labels not being lined up with each other and with the lines of the jacket. Additionally, as undercoat colors for the jackets change and evolve, the colors and glossing of the labels may not coordinate as well and the labels may give the water heater an outdated look.

Such known methods for fabricating the jacket can result in phosphate disposal from the washing operations, involve energy consumption for the ovens and washers, is human-labor intensive, and is difficult to automate in whole or in part.

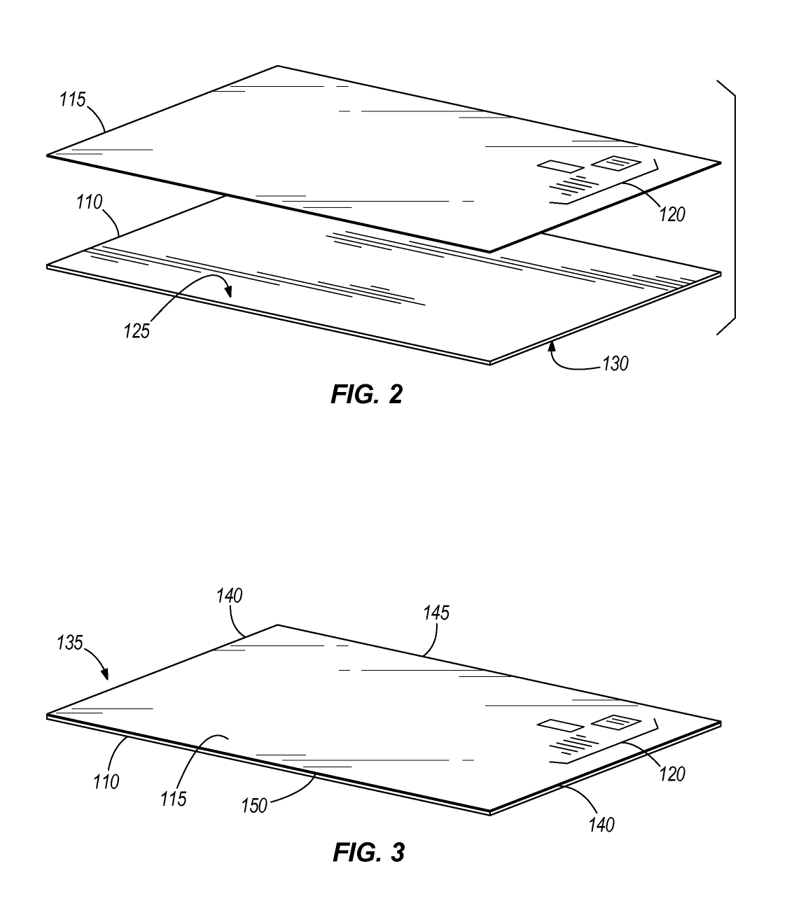

With reference to FIG. 2, the water heater jacket 22 made according to the present invention includes a metal sheet 110, a coating 115 applied to the metal sheet, and content 120 applied to the coating 115.

The term “metal sheet 110” describes any suitable substrate for the water heater jacket 22, which is typically a sheet of metal. The metal sheet 110 can be provided as pre-cut sheets, presized sheets, or in the form of a rolls or coils of material. As will be noted below, some or minimum cleaning and drying may be done to the metal sheet 110 if it is provided in a condition that is not very clean, although the present method has a higher tolerance for dirt and oil typically found on steel sheets. In the case of a roll of material, the metal sheet 110 is the portion of the roll of material that will eventually be cut from the roll and used for the water heater jacket 22. The metal sheet 110 may be made of any suitable material for a water heater jacket, with steel being one of the most common materials. The metal sheet 110 includes a first surface 125 and a second surface 130 facing an opposite direction from the first surface 125.

The term “coating 115” refers to a base layer of film or paint that is applied to the first surface 125 of the metal sheet 110. Suitable materials for the coating 115 in the form of a film include thermoplastic layers, such as polyvinyl, polyethylene, polypropylenes, and polyesters. Film thickness may be in the range of 0.1 mils to 1.5 mils, although 0.3 to 0.7 mils is preferred. The coating 115 can be clear or in white, grey, blue or any color. Films may include pre-colored or clear polymer film, adhesives, and paper liners. Adhesives can be solvent based, water based, or a hot melt adhesive. Adhesives can be acrylic, butyl rubber, epoxies, and urethane adhesive.

Suitable materials for the coating 115 in the form of paint include UV curable paints. An example of a suitable material is a mixture of acrylic, epoxy, polyester of monomers and/or oligomers.

The term “content 120” will be used to refer to images, text, labels, and other indicia that is to be applied to the coating 115. One example of content 120 is the information that is currently provided on labels applied to water heater jackets. The content 120 can be printed onto the coating 115 by on-line inkjet printing. Inkjet printing can incorporate a solvent based ink system, a water based ink system, a UV cured ink system, an LED cured ink system, a heat cured ink system, or an air cured ink system.

In any of the examples below, a second coating may be applied over the coating 115 and content 120. The second coating may be, for example, a liquid UV curable extra durable clear coat similar to the coating 115, such as acrylic, polyester, urethane in monomers and/or oligomers. The second coating is preferably clear and has a range of film thickness of 0.1 mils to 1.5 mils, although 0.3 mils to 0.7 mils is preferred.

The content 120 can be applied onto pre-punched, machined, no-machined or no-punched steel sheets. Un-punched steel sheets can be punched for holes or other shapes after the content 120 is applied.

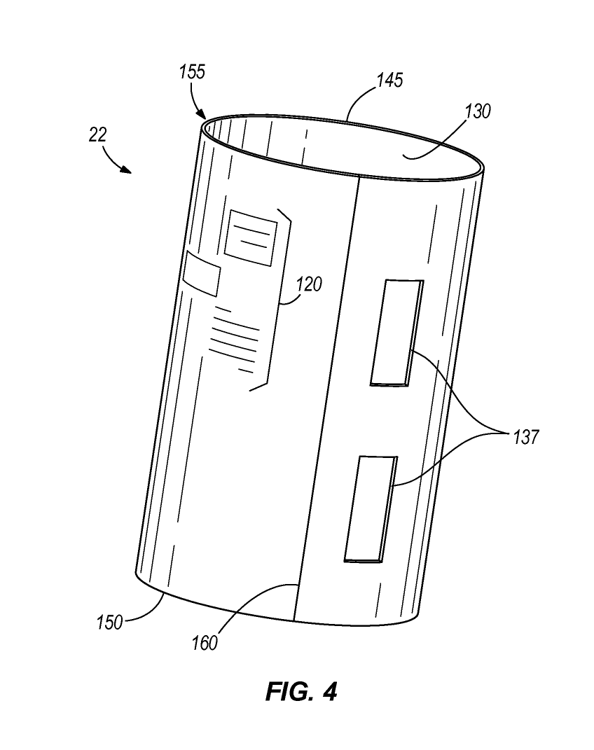

Referring now to FIG. 3, the result of each of the examples that will follow is a printed sheet 135, which comprises the metal sheet 110, the coating 115, and the content 120. The printed sheet 135 includes side edges 140, a top edge 145, and a bottom edge 150.

With reference to FIG. 4, the printed sheet 135 can be punched or cut to provide the required openings 137 to accommodate water heater components (e.g., the heating source 14), and then rolled, rolled formed, rolled locked, or spot welded into a cylinder 155. When in the shape of a cylinder 155, the side edges 140 come into contact and are crimped together to form a longitudinal seam 160. The first surface 125 of the metal sheet 110 faces out and the second surface 130 faces in. The top and bottom edges 145, 150 of the printed sheet 135 define the respective top and bottom edges of the cylinder 155.

With the seam 160 formed in the cylinder 155, the cylinder has become a finished jacket 22. Finished jackets 22 are tested, for example, by immersion in 212 degree Fahrenheit, salt spray test, flexibility, UV exposure tests, direct and reverse impact tests. The jacket 22 can be installed on the storage tank 12 of the water heater 10.

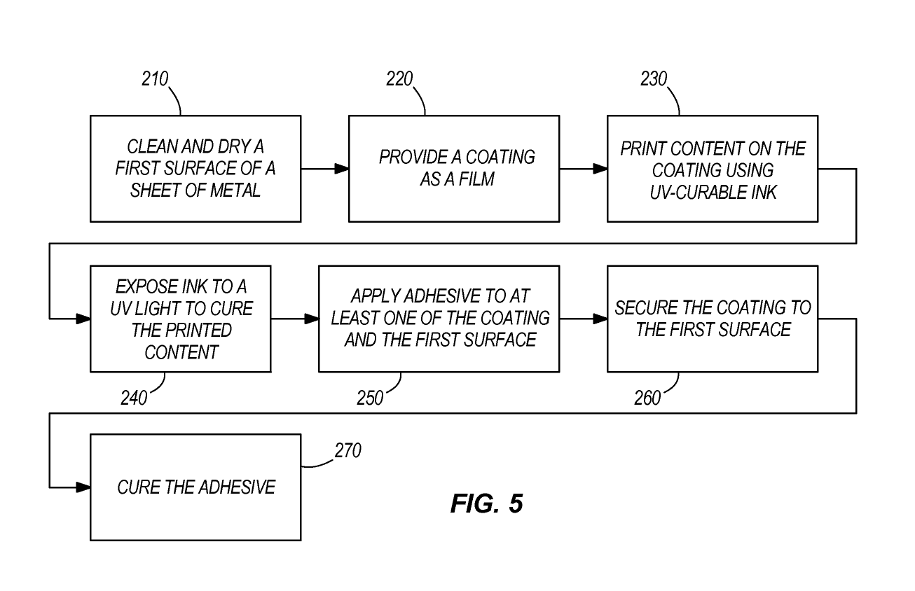

Several examples are provided in FIGS. 5-7 as to how the printed sheet 135 may be fabricated.

In FIG. 5, step 210 includes cleaning and drying the first surface 125 of the metal sheet 110 to remove dirt and oil. In step 220, the coating 115 is provided in the form of a film. In step 230, the content 120 is printed on the coating 115 with an inkjet printer and UV curable ink. In step 240, the content 120 is exposed to UV light 242 to cure the UV curable ink that is used to generate the content 120. In step 250, an adhesive 252 is applied to at least one of the coating 115 and the first surface 125. In step 260, the coating 115 is secured to the first surface 125 with the adhesive 252. This step may be accomplished with a commercially available film applicator. In step 270, the adhesive is permitted to cure, which results in the printed sheet 135.

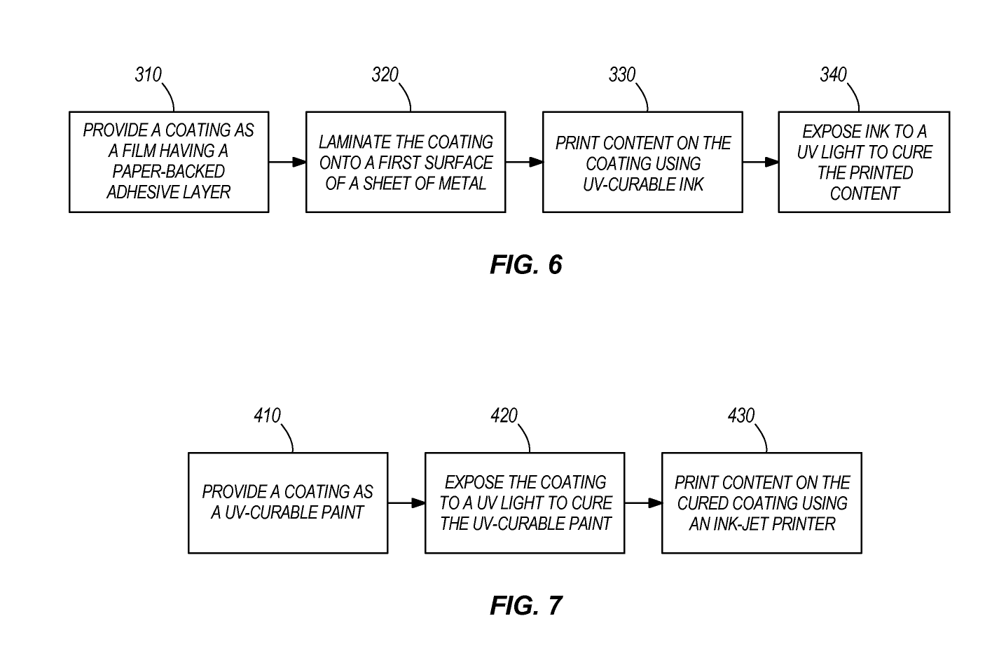

In FIG. 6, step 310 includes providing the coating 115 in the form of a film. The film includes an adhesive that is protected by a backing layer of paper. In step 320 the coating 115 is laminated onto the first surface 125 of the metal sheet 110. The laminating process involves peeling the backing layer from the film as the film is unrolled, and sticking the exposed adhesive to the first surface 125 of the metal sheet 110 as the backing layer is peeled away. The metal sheet 110, coating 115, or both may be moved with respect to the other during the laminating process. After the adhesive has cured, the process moves to step 330, in which the content 120 is printed on the coating 115 with an inkjet printer and UV curable ink. In step 340, the content 120 is exposed to UV light to cure the UV curable ink that is used to generate the content 120, which results in the printed sheet 135. This example is more tolerant of oil and dirt on the first surface 125 than the previous example, and does not require a thorough cleaning step before applying the coating 115. A preferred film for the coating 115 in this example is 1.0 mil polyester with 1.0 butyl rubber adhesive.

FIG. 7 illustrates another example of the method according to the present invention. In step 410 the coating 115 is provided in the form of UV-curable paint. The UV-curable paint is applied to the first surface 125 of the metal sheet 110 with a roll-coating machine. In step 420 the coating 115 is exposed to UV light to cure the UV-curable paint. One advantage of this example is that the UV-curable paint cures very quickly, in about eight seconds. In step 430, the content 120 is printed on the cured coating 115 with an inkjet printer. The inkjet printer applies the content 120 in a dry condition, so there is no need for an additional drying step. In other words, the printed sheet 135 is complete immediately after step 430. This example provides excellent flexibility because the color and information of the coating 115 and content 120 can be changed easily. The UV-curable paint used as the coating 115 in this example could result in lower inventory compared to the two preceding examples that would require a stockpile of film for the coating 115.

In the example of FIG. 7, step 410 may include applying a primer coat to the sheet of steel, and then applying a liquid color coat over the primer coat. The primer coat could be a UV curable primer coat, which is cured under UV light prior to applying the color coat. The liquid color coat may also be UV curable. The method may further include applying a clear top coat over the color coat and content to create the printed sheet of steel.

In all examples above, the method is intended to work within cycle times currently required for fabrication of water heater jackets. For example, present method provides a cycle time for individual steps no greater than thirty seconds. In the third example, in which UV-curable paint is used as the coating 115, cycle time for each of the steps of applying the coating 115 and printing the content 120 is no greater than fifteen seconds. The curing step for the UV-curable paint used as the coating 115 may be as low as eight seconds. If a UV-curable primer and a UV-curable liquid color coat are applied, each may take as low as eight seconds to cure under UV light.

One additional benefit of the present method, which arises from printing all content 120 on the printed sheet 135 in one step, is the elimination of the time and inventory associated with applying individual labels to the jacket post-fabrication. Additionally, the method produces excellent finishing quality of labels with precision and flexibility. Labels, special design of labels, and art works can be produced quickly and on-line.

Another benefit of the present method is that jacket fabrication can be automated to a greater extent than previously possible, since the coating 115 and content 120 are applied at workstations that may be computer-controlled or assisted.

Another benefit of the present method is the elimination or reduction of phosphate disposal from washing stages, and the elimination of paint wastes. This invention eliminates the need of energy requirements for ovens and washers.

In view of the foregoing, the method of the present invention has the potential to provide costs savings in the jacket production process, disposal of materials, energy requirements, and material costs over known processes for manufacturing jackets. This method of the present invention also has the potential to improve the quality of appearance of a finished jacket over known processes for manufacturing jackets.

1. A method of manufacturing a water heater, the method comprising:
a. providing a water storage tank for storing water;
b. providing a heating source for heating water stored in the tank;
c. providing a sheet of metal including a first surface;
d. applying a coating to the first surface;
e. printing content onto the coating;
f. forming the sheet into a cylinder, the cylinder including two open ends; and
g. positioning the water storage tank and the heating source within the cylinder.

2. The method of claim 1, wherein step (d) includes applying a UV-curable paint, the method further comprising the step of curing the coating by exposing the coating to UV light between steps (d) and (e).

3. The method of claim 2, wherein step (e) includes printing content with an inkjet printer.

4. The method of claim 2, wherein step (e) occurs before step (f).

5. The method of claim 2, wherein step (d) is executed in no more than thirty seconds; wherein the step of curing the coating is executed in no more than thirty seconds; and wherein step (e) is executed in no more than thirty seconds.

6. The method of claim 1 wherein step (d) includes applying a film having a thermoplastic layer and an adhesive such that the adhesive secures the film to the first surface.

7. The method of claim 6, wherein step (e) occurs before step (d).

8. The method of claim 6, wherein step (e) occurs after step (d).

9. A method of manufacturing a water heater jacket, the method comprising:
a. providing a sheet of metal including a first surface;
b. applying a paint to the first surface, resulting in a painted sheet;
c. curing the paint, resulting in a cured sheet;
d. printing content onto the cured sheet, resulting in a printed sheet; and
e. forming the printed sheet into a cylinder, the cylinder including two open ends and being sized to fit over a water heater storage tank.

10. The method of claim 9, wherein step (b) includes applying a UV-curable paint; and
wherein step (c) includes exposing the paint to UV light.

11. The method of claim 9, wherein step (d) includes printing content with an inkjet printer.

12. The method of claim 9, wherein each of steps (b), (c), and (d) is accomplished in no more than thirty seconds.

13. The method of claim 9 further comprising: applying a clear paint to the printed sheet, resulting in a clear painted sheet; and curing the clear paint, resulting in a cured clear painted sheet.

14. The method of claim 9 further comprising: cleaning the first surface prior step (b).

15. The method of claim 9, wherein step (d) occurs before step (e).

16. A method of manufacturing a water heater jacket, the method comprising:
a. providing a sheet of metal including a first surface;
b. providing a film including a thermoplastic layer and an adhesive;
c. securing the film to the first surface with the adhesive;
d. printing content onto the thermoplastic layer, resulting in a printed sheet; and
e. forming the printed sheet into a cylinder, the cylinder including two open ends.

17. The method of claim 16, wherein step (d) occurs before step (c).

18. The method of claim 16, wherein step (d) occurs after step (c).

19. The method of claim 16, wherein step (d) occurs before step (e).

20. The method of claim 16, wherein step (d) includes printing with an inkjet printer.

21. A method of manufacturing a water heater jacket comprising the steps of:
a. providing a sheet of steel;
b. applying a primer coat to the sheet of steel;
c. applying a color coat over the primer coat;
d. printing label information on top of the color coat;
e. applying a clear top coat over the color coat and label information to create a printed sheet of steel; and
f. forming the printed sheet of steel into a cylinder of a desired diameter to surround a water heater tank.

22. The method of claim 21, wherein step (a) includes providing the sheet of steel as part of a coil of steel, the method further comprising the step of cutting the sheet of steel from the coil of steel after step (c).

23. The method of claim 21, wherein step (b) includes applying a UV curable primer coat to the sheet of steel and curing the primer coat under UV light.

24. The method of claim 21, wherein step (c) includes applying a UV curable liquid color coat over the primer and curing the color coat under UV light.

25. The method of claim 21, wherein step (d) includes printing the label information with UV curable ink using an inkjet printer.
